(19) United States
(12) Patent Application Publication
(10) Pub. No.: US 2023/0400688 A1
(43) Pub. Date: Dec. 14, 2023

(54) WEARABLE DEVICE WITH CAMERA

(71) Applicant: GOOGLE LLC, Mountain View, CA (US)

(72) Inventors: Vyacheslav Malyugin, Waterloo (CA); Nathan Calvin Kaun, Kitchener (CA); Cecilia Ka Vai Mok, Kitchener (CA)

(21) Appl. No.: 17/806,876

(22) Filed: Jun. 14, 2022

(51) Int. Cl. G02B 27/01; H04N 5/225; G06F 1/16

(52) U.S. Cl. CPC G02B 27/017; H04N 5/2252; G06F 1/163; G02B 2027/0138

(57) ABSTRACT

A method can include, based on a context of a wearable device, periodically capturing and storing, by the wearable device, multiple images, the multiple images being stored in a buffer included in the wearable device, periodically erasing a least-valuable image, from among the multiple images, from the buffer, receiving a request to view the multiple images stored in the buffer, and in response to the request to view the multiple images stored in the buffer, outputting the multiple images stored in the buffer.

### TECHNICAL FIELD

This description relates to wearable devices.

### BACKGROUND

Users may view scenes, and wish they had captured photographs of events that have already happened. Unfortunately, capturing photographs of events that have already happened may not be possible.

### SUMMARY

In some aspects, techniques described herein relate to a method including: based on a context of a wearable device, periodically capturing and storing, by the wearable device, multiple images, the multiple images being stored in a buffer included in the wearable device; periodically erasing a least-valuable image, from among the multiple images, from the buffer; receiving a request to view the multiple images stored in the buffer; and in response to the request to view the multiple images stored in the buffer, outputting the multiple images stored in the buffer.

In some aspects, the techniques described herein relate to a method, further including: determining a selected image based on receiving a selection of one of multiple images; erasing images from the multiple images other than the selected image; and transferring the selected image from the buffer to long-term storage.

In some aspects, the techniques described herein relate to a method, wherein the least-valuable image includes an oldest-captured image.

In some aspects, the techniques described herein relate to a method, wherein the outputting of the multiple images includes: sending the multiple images to a mobile device; and prompting the mobile device to display the multiple images.

In some aspects, the techniques described herein relate to a method, wherein the outputting of the multiple images includes displaying the multiple images.

In some aspects, the techniques described herein relate to a method, wherein the wearable device includes a head-mounted device.

In some aspects, the techniques described herein relate to a method, wherein the multiple images have lower resolutions than a maximum resolution of a camera included in the wearable device.

In some aspects, the techniques described herein relate to a method, wherein the periodically capturing the images is performed without user instruction.

In some aspects, the techniques described herein relate to a method, wherein the periodically erasing the least-valuable image is performed without user instruction.

In some aspects, the techniques described herein relate to a method, wherein a period between capturing images within the multiple images is at least half of a second.

In some aspects, the techniques described herein relate to a method, wherein an oldest image from the multiple images stored in the buffer was captured at least three seconds before a current time.

In some aspects, the techniques described herein relate to a method, wherein an oldest image from the multiple images stored in the buffer was captured no more than fifteen seconds before a current time.

In some aspects, the techniques described herein relate to a method, further including, in response to the request to view the multiple images stored in the buffer, increasing an output of a light source included in the wearable device.

In some aspects, the techniques described herein relate to a method, further including: determining that an interest level satisfies an interest threshold, the interest level being based on images captured before the multiple images, wherein the storing the multiple images is performed based on the interest level satisfying the interest threshold.

In some aspects, the techniques described herein relate to a wearable device including: a camera; at least one processor; and a non-transitory computer-readable storage medium including instructions thereon that, when executed by the at least one processor, are configured to cause the wearable device to: based on a context of a wearable device, periodically capture and store, by the wearable device, multiple images, the multiple images being stored in a buffer included in the wearable device; periodically erase a least-valuable image, from among the multiple images, from the buffer; receive a request to view the multiple images stored in the buffer; and in response to the request to view the multiple images stored in the buffer, output the multiple images stored in the buffer.

In some aspects, the techniques described herein relate to a wearable device, wherein the outputting of the images includes: sending the images to a mobile device; and prompting the mobile device to display the images.

In some aspects, the techniques described herein relate to a wearable device, wherein the outputting of the images includes displaying the images.

In some aspects, the techniques described herein relate to a non-transitory computer-readable storage medium including instructions thereon that, when executed by at least one processor, are configured to cause a wearable device to: based on a context of a wearable device, periodically capture and store, by the wearable device, multiple images, the multiple images being stored in a buffer included in the wearable device; periodically erase a least-valuable image, from among the multiple images, from the buffer; receive a request to view the multiple images stored in the buffer; and in response to the request to view the multiple images stored in the buffer, output the multiple images stored in the buffer.

In some aspects, the techniques described herein relate to a non-transitory computer-readable storage medium, wherein the outputting of the images includes: sending the images to a mobile device; and prompting the mobile device to display the images.

In some aspects, the techniques described herein relate to a non-transitory computer-readable storage medium, wherein the outputting of the images includes displaying the images.

The details of one or more implementations are set forth in the accompanying drawings and the description below. Other features will be apparent from the description and drawings, and from the claims.

### BRIEF DESCRIPTION OF THE DRAWINGS

FIG. 1 shows a user of a wearable device viewing a scene.

FIG. 2A shows a first image of the scene captured by the wearable device of FIG. 1.

FIG. 2B shows a second image of the scene captured by the wearable device of FIG. 1.

FIG. 2C shows a third image of the scene captured by the wearable device of FIG. 1.

FIG. 3A shows the user wearing the wearable device and holding a mobile device.

FIG. 3B shows the mobile device of FIG. 3A displaying the images captured in FIGS. 2A, 2B, and 2C.

FIG. 4A shows images stored in a buffer at a first time.

FIG. 4B shows images stored in the buffer at a second time.

FIG. 4C shows images stored in the buffer at a third time.

FIG. 5 is a block diagram of the wearable device.

FIG. 6 is a flowchart showing a method performed by the wearable device.

FIG. 7A is a front view, and FIG. 7B is a rear view, of an example wearable device.

FIG. 8 is a flowchart showing another method performed by the wearable device.

FIG. 9 shows an example of a computer device and a mobile computer device that can be used to implement the techniques described here.

Like reference symbols in the various drawings indicate like elements.

### DETAILED DESCRIPTION

A wearable device, such as smartglasses, can maintain a sliding window of captured images for presentation to a user upon request. The wearable device can, for example, capture images automatically and/or without user intervention, such as periodically. The wearable device can periodically erase captured images from a buffer to maintain memory available for newly-captured images. Upon user request, the wearable device can output the captured images that are stored in the buffer. The wearable device can output the captured images by presenting the captured images on a display included in the wearable device, and/or by transmitting the captured images to another computing device. The user can select one or more of the outputted images to save in long-term storage.

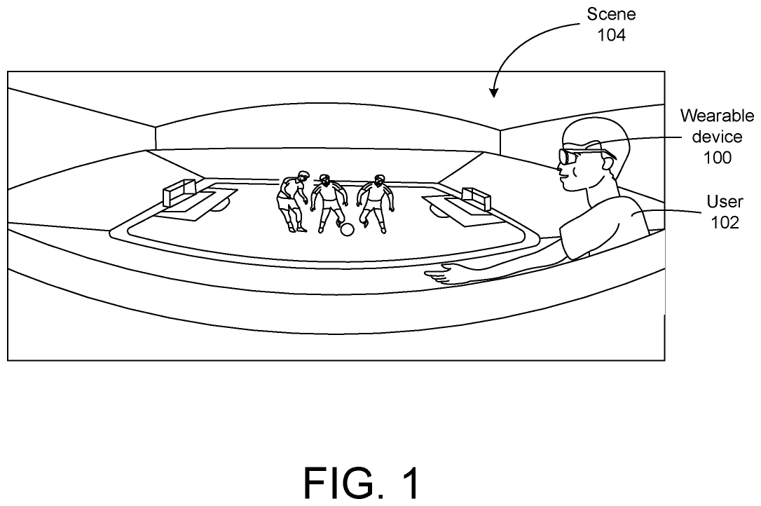

FIG. 1 shows a user 102 of a wearable device 100 viewing a scene 104. The user 102 can be wearing the wearable device 100 on a head of the user 102. In some examples, the wearable device 100 can include smartglasses supported by a nose and ears of the user 102.

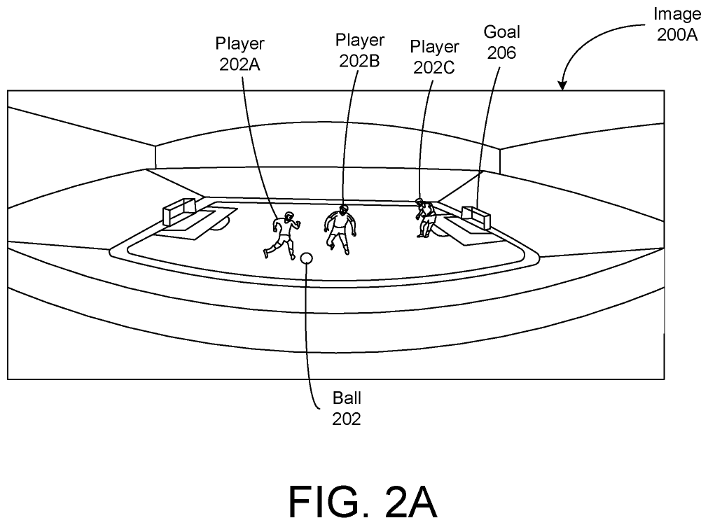

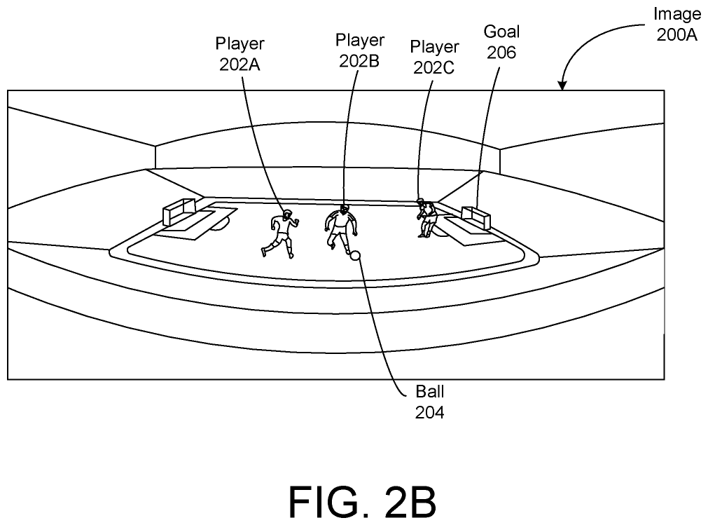

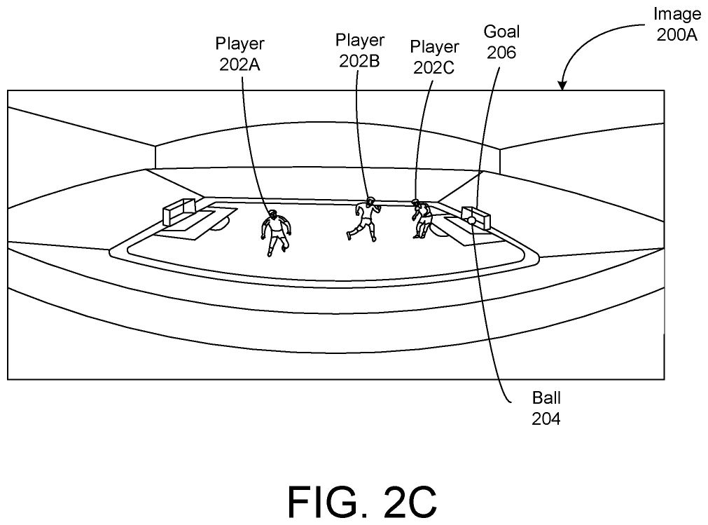

The user can view a scene 104. A camera included in the wearable device 100 can capture images of the scene 104. In the example shown in FIG. 1, the scene 104 is a soccer game. FIGS. 2A, 2B, and 2C show images of the scene 104 captured by the wearable device 100.

The wearable device 100 can capture multiple images periodically, such as every second, or every half-second (0.5 seconds), as non-limiting examples. In some examples, the multiple images can be periodically captured for purposes other than presentation to a user upon request, such as to determine a context of the wearable device 100. The wearable device 100 can maintain, and/or store, images that were captured within a predefined previous time period, such as the last five seconds or the last ten seconds. The predefined time period can limit the memory required to maintain the captured images. The predefined period can be a time within which a user is likely to request to view the recently-captured content (the recently-captured content can include the captured images).

In some examples, the wearable device 100 can capture and/or store multiple images based on the wearable device 100 determining that an interest level satisfies an interest threshold. The wearable device 100 can determine the interest level based on images captured by the wearable device 100, a time of day, movements of the wearable device 100, and/or a location of the wearable device 100. In some examples, if the wearable device 100 determines that the interest level does not satisfy the interest threshold, the wearable device 100 can capture images at a lower frequency until determining that the interest level does satisfy the interest threshold, and then increase the frequency of capturing images after determining that the interest level does satisfy the interest threshold. In some examples, the interest level can be based on whether captured images change, with changing images increasing the interest level and static images lowering the interest level. In some examples, the interest level can be based on image recognition, with the interest level increasing for categories of images, such as sporting events, that the user 102 has previously indicated interest in. In some examples, the interest level can be higher during waking hours for the user 102 and lower during non-waking hours for the user. In some examples, if movements of the wearable device 100 indicate that the user 102 is focusing on a scene, such as the scene 104, the interest level may be increased. In some examples, if the wearable device 100 is in a location in which the user 102 and/or other users are likely to capture photographs and/or images, the interest level can be increased.

FIG. 2A shows a first image 200A of the scene 104 captured by the wearable device 100 of FIG. 1. This image 200A shows a first player 202A about to kick a ball 204, a second player 202B defending against the first player 202A, and a third player 202C acting as a goalkeeper and standing in front of a goal 206.

FIG. 2B shows a second image 200B of the scene 104 captured by the wearable device 100 of FIG. 1. The wearable device 100 captured the second image 200B after capturing the first image 200A. This image 200B shows the first player 202A having kicked the ball 204 past the second player 202B toward the goal 206.

FIG. 2C shows a third image 200C of the scene 104 captured by the wearable device 100 of FIG. 1. The wearable device 100 captured the third image 200C after capturing the second image 200B. This image 200C shows the ball 204 having traveled past the third player 202C acting as the goalkeeper and into the goal 206.

The time period between capturing the first image 200A and capturing the second image 200B can be equal to the time period between capturing the second image 200B and capturing the third image 200C. The time period between capturing the first image 200A and the second image 200B, and the time period between capturing the second image 200B and capturing the third image 200C, can be at least half of a second. The wearable device 100 may have captured the first image 200A, second image 200B, and third image 200C with a lower resolution than a maximum resolution of a camera included in the wearable device 100, to reduce usage of memory and/or other computing resources.

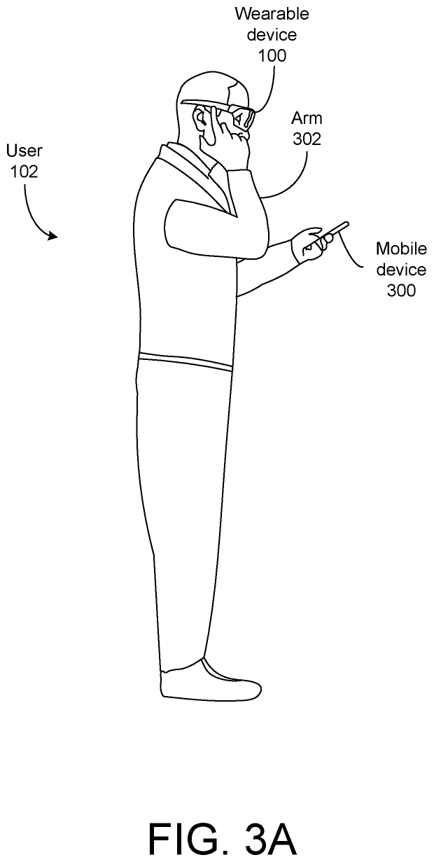

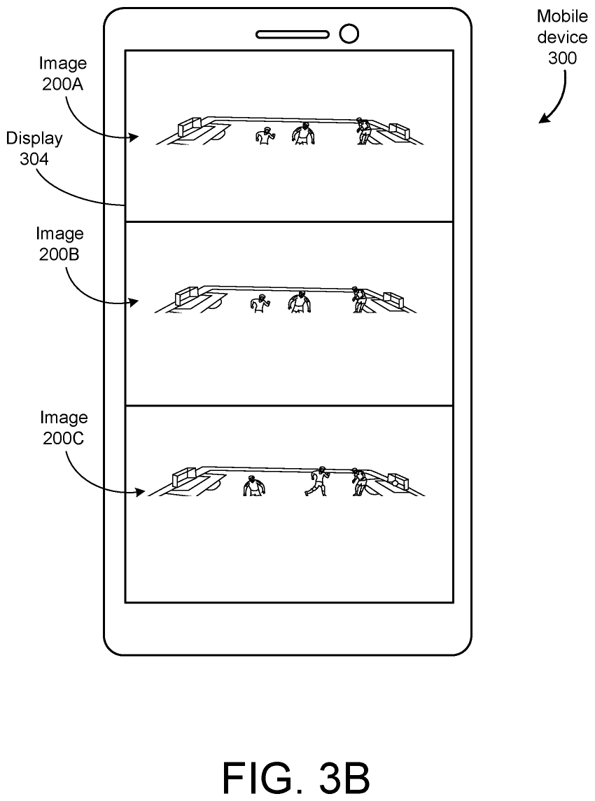

FIG. 3A shows the user 102 wearing the wearable device 100 and holding a mobile device 300. The mobile device 300 can include a smart phone or a tablet computing device, as non-limiting examples. The user 102 may wish that the user 102 had captured a picture of the player 202A kicking the ball 204 into the goal 206.

The user 102 can request to view recently-captured content, such as the multiple images 200A, 200B, 200C of the scene 104 captured by the wearable device 100. The user 102 can request to review the recently-captured content by pressing a button on the wearable device 100 with a portion of an arm 302 of the user 102 (such as the user's 102 finger), or by orally instructing the wearable device 100 to present the recently-captured content, as non-limiting examples.

The wearable device 100 can respond to the request by outputting the recently-captured content, which can include one or more of, or multiple of, the images 200A, 200B, 200C. The wearable device 100 can output the recent-captured content by presenting one or more of the multiple images 200A, 200B, 200C on a display included in the wearable device 100, or by transmitting and/or sending the one or more of the multiple images 200A, 200B, 200C to another electronic device, such as a mobile device. While three recently-captured images 200A, 200B, 200C are shown and described herein, any number of recently-captured images can be maintained in a sliding window and/or outputted, such as five or ten recently-captured images, as non-limiting examples.

FIG. 3B shows the mobile device 300 of FIG. 3A displaying the images captured in FIGS. 2A, 2B, and 2C. The mobile device 300 can include a display 304 that displays and/or presents the images 200A, 200B, 200C. In this example in which the mobile device 300 displays the recently-captured content including the images 200A, 200B, 200C, the wearable device 100 has transmitted the images 200A, 200B, 200C to the mobile device 300, such as via a wireless interface.

The wearable device 100 can maintain a sliding window, erasing and/or deleting an oldest captured image as a new image is stored. The wearable device 100 can, by maintaining the sliding window, store a constant number of images in a buffer. In an example in which the buffer stores two images, the wearable device 100 can capture a first image, store the first image, capture a second image, store the second image, capture a third image, store the third image, and, to free memory to store the third image, erase the first image. In some examples, the buffer can store more than or three two images.

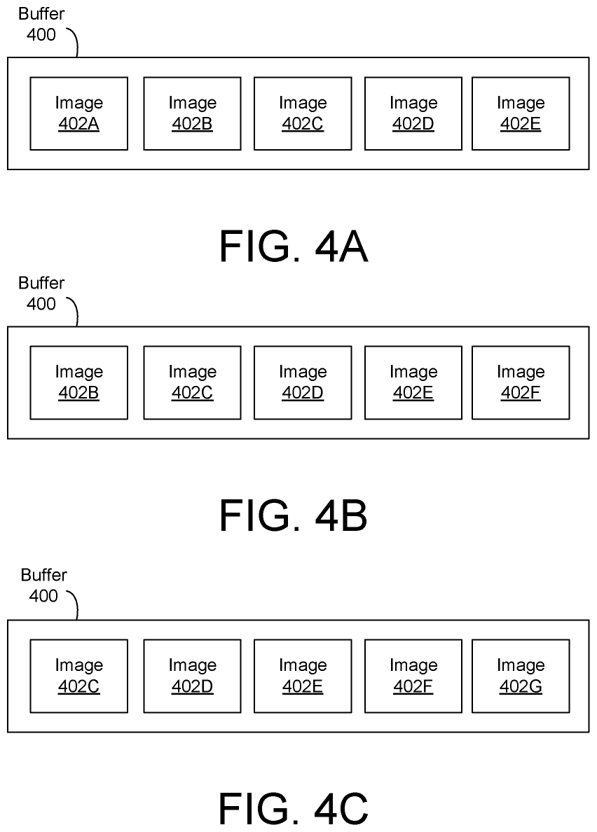

FIG. 4A shows images 402A, 402B, 402C, 402D, 402E stored in a buffer 400 at a first time. The images 402A, 402B, 402C, 402D, 402E can be included in a sliding window maintained by the wearable device 100. The buffer 400 can be included in the wearable device 100. In this example, the buffer 400 stores five captured images 402A, 402B, 402C, 402D, 402E. This is merely an example. In other examples, the buffer 400 can store other numbers of captured images. In this example, the buffer 400 has stored five captured images 402A, 402B, 402C, 402D, 402E. The images 402A, 402B, 402C, 402D, 402E may have been captured periodically, such as every second. The images 402A, 402B, 402C, 402D, 402E can be captured images of the scene 104. In this example, a first image 402A was captured earliest (and can be considered an oldest image, earliest-captured image, and/or an oldest-captured image), a second image 402B was captured second earliest, a third image 402C was captured third earliest, a fourth image 402D was captured fourth earliest, and a fifth image 402D was captured last (and can be considered a newest image, most-recently captured image, and/or a newest-captured image).

FIG. 4B shows images stored in the buffer 400 at a second time. The second time is later in time than the first time. The images 402B, 402C, 402D, 402E, 402F can be included in the sliding window maintained by the wearable device 100. In this example, the wearable device 100 has captured a sixth image 402F. To make room for the most-recently captured image 402F, the wearable device 100 has erased the earliest-captured image 402A. The most-recently captured image 402F can replace the earliest-captured image 402A in the buffer 400.

FIG. 4C shows images stored in the buffer at a third time. The third time is later in time than the first time and the second time. The images 402C, 402D, 402E, 402F, 402G can be included in the sliding window maintained by the wearable device 100. In this example, the wearable device 100 has captured a seventh image 402G To make room for the most-recently captured image 402G, the wearable device 100 has erased the now earliest-captured image 402B. The most-recently captured image 402G can replace the earliest-captured image 402B in the buffer 400.

In some examples, an oldest image stored in the buffer 400 (the oldest image stored in the buffer 400 can be the image 402A in the example shown in FIG. 4A, the image 402B in the example shown in FIG. 4B, and the image 402C in the example shown in FIG. 4C) has been captured at least three seconds before a current time, reflecting a sliding window of pictures and/or images that is at least three seconds long. In some examples, the oldest image stored in the buffer 400 has been captured no more than fifteen seconds before the current time, reflecting a sliding window of pictures and/or images that is no more than fifteen seconds long. The wearable device 100 can continuously capture, store, and/or replace images 402A, 402B, 402C, 402D, 402E, 402F, 402G without user interaction.

While the earliest-captured image, and/or oldest-captured image, has been described as being replaced by the newest image, this is merely an example of the least-valuable image being replaced by the newest image. The oldest-captured image is an example of the least-valuable image. The least-valuable image could be the image 402A, 402B, 402C, 402D, 402E, 402F, 402G stored in the buffer 400 that the wearable device 100 determines is least valuable based on factors such as the age of the image 402A, 402B, 402C, 402D, 402E, 402F, 402G, a quality of the image (such as based on a measurement of how blurred the image 402A, 402B, 402C, 402D, 402E, 402F, 402G is and/or a measurement of whether the image 402A, 402B, 402C, 402D, 402E, 402F, 402G is underexposed and/or overexposed), and/or based on content of the image (such as whether the image includes persons with smiling faces or less desirable facial expressions), as non-limiting examples.

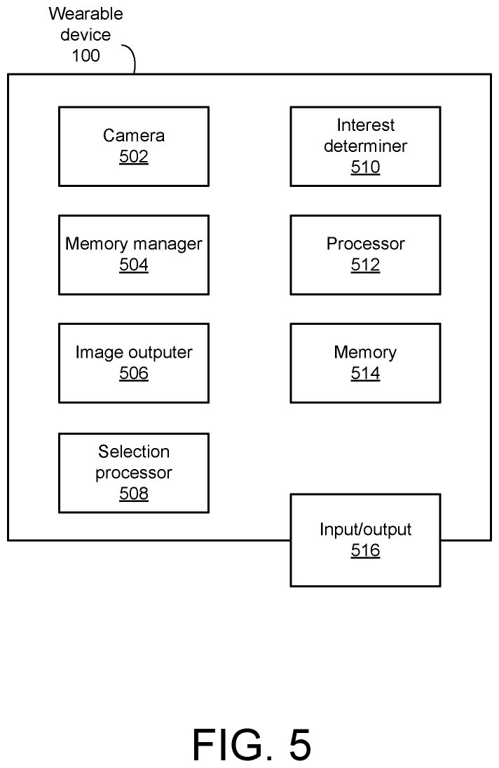

FIG. 5 is a block diagram of the wearable device 100. The wearable device 100 can include a camera 502. The camera 502 can capture and/or store images, such as photographs. The camera 502 can capture and/or store the images automatically and/or without user intervention or request (such as an instruction to activate the camera shutter). The camera 502 can capture and/or store the images periodically, such as once per second or once per half second.

The wearable device 100 can include a memory manager 504. The memory manager 504 can manage the data and/or images stored in the buffer 400. The memory manager 504 can store and/erase images captured by the camera 502. In some examples, the memory manager 504 can maintain the sliding window of images captured by the camera 502 in the recent past. The memory manager 504 can, for example, erase images on a first-in first-out basis. The memory manager 504 can, for example, erase the earliest and/or oldest images to free memory to store newly-captured images.

While the memory manager 504 can erase the earliest and/or oldest images to free memory to store newly-captured images, this is merely an example of erasing the least-valuable image. The memory manager 504 can determine the lease-valuable image based on the age of the images, quality of images, and/or content of the images, as described above.

The wearable device 100 can include an image outputter 506. The image outputter 506 can output images in response to a request from the user 102. The image outputter 506 can, for example, output images stored in the buffer 400 in response to the request. The image outputter 506 can output the images by, for example, presenting the images on a display included in the wearable device 100, or by transmitting the images to another electronic device, such as the mobile device 300.

The wearable device 100 can include a selection processor 508. The selection processor 508 can process the selection of one or more images outputted by the image outputter 506. In some examples, the user 102 can select an image displayed by the wearable device 100, such as by tapping or providing oral or audible selection of the image. In some examples, the user 102 can select an image displayed by the other electronic device such as the mobile device 300 by tapping on the image. The selection processor 508 can respond to the selection by transferring to, and/or storing the selected image in, long-term storage. The long-term storage can include a portion of a memory device 514 included in the wearable device 100 that stores data for longer times than the buffer 400, or a memory device outside the wearable device 100, such as remote (“cloud”) storage. In the example of remote storage, storage of an image(s) in long-term storage by the wearable device can include transmitting and/or sending the image(s) to a remote storage device, such as via the Internet.

The wearable device 100 can include an interest determiner 510. The interest determiner 510 can determine whether images captured by the wearable device 100 are likely to be interesting, and/or whether the wearable device 100 should automatically capture images without user input, based on a context of the wearable device. In some examples, the interest determiner 510 can instruct the camera 502 to periodically store and capture images in the buffer 400 based on the wearable device 100 being on and worn on a predetermined body part of the user 102, such as a head of the user.

If the interest determiner 510 determines that the images are likely to be interesting based on a context of the wearable device 100, then the wearable device 100 can capture and/or store images without requests and/or prompting from the user 102. In some examples, the interest determiner 510 can determine the interest level based on a sequence of images, such as a first image, second image, and third image. In some examples, the interest level can be based on whether images in the sequence of images change. If the interest determiner 510 determines that the images are not likely to be interesting, then the wearable device 100 may not capture images, or may capture the images but not store the images. The interest determiner 510 can determine whether images are likely to be interesting based on whether images are changing, or based on contextual considerations such as a time of day or location of the wearable device 100, as non-limiting examples.

In some examples, the wearable device 100 can automatically capture images, and the interest determiner 510 can determine whether the already-captured images are likely to be requested by the user 102 to be saved and/or outputted. The interest determiner 510 can instruct the memory manager 504 to replace, delete, and/or erase captured images that are less likely to be interesting to the user 102 (which can be considered less valuable images and/or a least-valuable images), making room in the memory 514 and/or buffer 400 for captured images that are more valuable and/or more likely to be interesting to the user. The wearable device 100 can temporarily store the more interesting images, allowing the user 102 to select one or more of the more interesting images for longer storage.

The wearable device 100 can include at least one processor 512. The at least one processor 512 can execute instructions, such as instructions stored in at least one memory device 514, to cause the wearable device 100 to perform any combination of methods, functions, and/or techniques described herein.

The wearable device 100 can include at least one memory device 514. The at least one memory device 514 can include a non-transitory computer-readable storage medium. The at least one memory device 514 can store data, such as data and/or images stored in the buffer 400, and instructions thereon that, when executed by at least one processor, such as the processor 512, are configured to cause the wearable device 100 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the wearable device 100 can be configured to perform, alone, or in combination with the wearable device 100, any combination of methods, functions, and/or techniques described herein. The at least one memory device 514 can include the buffer 400 and long-term storage. The long-term storage can include a separate portion of the memory device 514, and/or a different component of the memory device 514, than the buffer 400. The memory manager 504 and/or wearable device 100 can transfer a selected image from the buffer 400 to the long-term storage.

The wearable device 100 can include at least one input/output node 516. The at least one input/output node 516 may receive and/or send data, such as from and/or to, the wearable device 100 and another electronic device, and/or may receive input and provide output from and to the user 102. The input and output functions may be combined into a single node, or may be divided into separate input and output nodes. The input/output node 516 can include the camera 502, a display, a speaker, and/or any wired or wireless interfaces (such as Bluetooth or Institute for Electrical and Electronics Engineers 802.11) for communicating with other electronic devices (such as the mobile device 300).

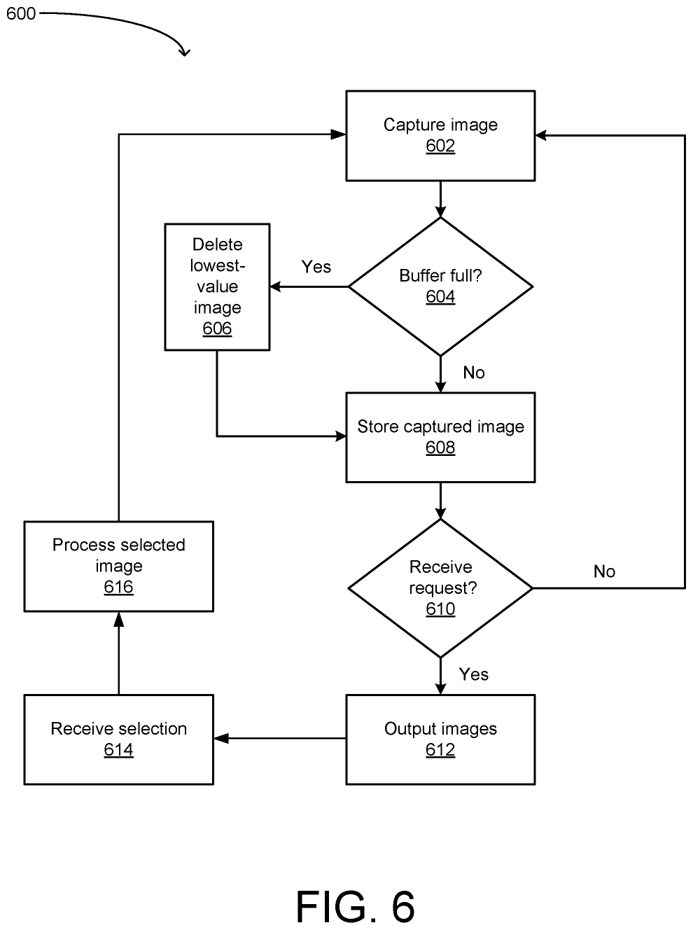

FIG. 6 is a flowchart showing a method 600 performed by the wearable device 100. The camera 502 can capture an image (602). After the camera 502 has captured the image (602), the wearable device 100 can determine whether the buffer 400 is full (604).

If the buffer is full, then the wearable device 100 can delete a lowest-value image (606) stored in the buffer 400. The lowest-value image can be, for example, and oldest image, the first captured image, and/or the first image 402A as described above with respect to FIGS. 4A and 4B. Deleting the lowest-value image and/or oldest image (606) can make memory available for storing the recently captured image.

After deleting the lowest-value image and/or oldest image (606), or if the buffer 400 was not full, the wearable device 100 can store the captured image (608). The captured image that is stored at (608) can be a most-recently captured and/or stored image.

After storing the captured image (608), and/or at any time during the method 600, the wearable device 100 can determine whether the wearable device 100 received a request (610) to view the captured content. The request can include, for example, manual input to the wearable device 100, such as a user pushing a button or tapping a specific location on a touchscreen included in the wearable device 100. If the wearable device 100 determines that the request was not received, then the wearable device 100 can continue capturing images (602).

If the wearable device 100 determines that the request was received, then the wearable device 100 can output the recently-captured images (612). The wearable device 100 can output the recently-captured images (612) as described above. In response to the determination that the request was received, the wearable device 100 can stop erasing and/or deleting images, to prevent the wearable device 100 from erasing and/or deleting an image that the user 102 is requesting to view. In some examples, the wearable device 100 can, based on stopping erasing and/or deleting images, also stop capturing images, because the buffer 400 remains full. In some examples, the wearable device 100 can, based on stopping erasing and/or deleting images, capture new images in a new buffer stored in a different portion of the memory device 514 than the original buffer 400.

After outputting the images (612), the wearable device 100 can receive a selection of one or more of the images (614). The wearable device 100 can receive the selection (614) based on a tap, click, or audible selection of the images, as non-limiting examples. The selection can be received (614) via the wearable device 100 or via an electronic device such as the mobile device 300 to which the wearable device 100 sent and/or transmitted the recently-captured images.

After receiving the selection (614), the wearable device can process the selected image (616), for which the selection was received at 614. The wearable device 100 can process the selected image (616) by, for example, transferring and/or storing the selected image in long-term storage. After processing the selected image (616), the wearable device 100 can continue capturing images (602).

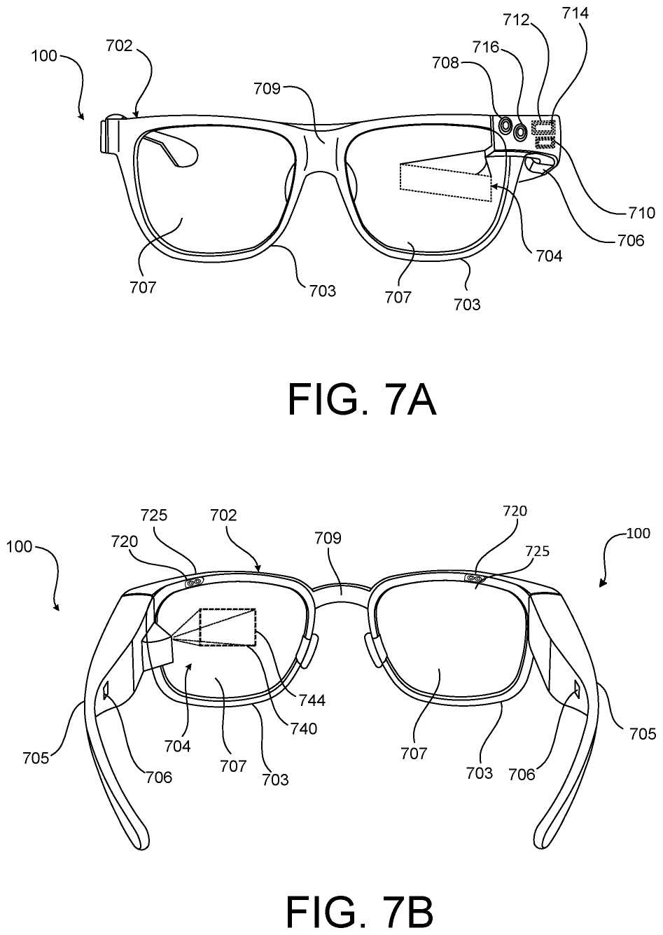

FIG. 7A is a front view, and FIG. 7B is a rear view, of an example wearable device 100. In this example, the wearable device 100 is a head-mounted device. In some implementations, the example wearable device 100 may take the form of a pair of smartglasses, or augmented reality glasses, as in the example shown in FIGS. 7A and 7B, or an augmented reality and/or virtual reality headset or goggles, and the like. Hereinafter, systems and methods in accordance with implementations described herein will be described with respect to the wearable device 100 in the form of smartglasses, simply for ease of discussion and illustration. The principles to be described herein can be applied to other types of wearable devices and/or combinations of mobile/wearable devices working together.

As shown in FIG. 7A, the example wearable device 100 includes a frame 702. In the example shown in FIGS. 7A and 7B, the frame 702 includes rim portions 703 surrounding glass portion(s) 707, or lenses 707, and arm portions 705 coupled to a respective rim portion 703. In some examples, the lenses 707 may be corrective/prescription lenses. In some examples, the lenses 707 may be glass portions that do not necessarily incorporate corrective/prescription parameters. In some examples, a bridge portion 709 may connect the rim portions 703 of the frame 702. A display device 704 may be coupled in a portion of the frame 702. In the example shown in FIGS. 7A and 7B, the display device 704 is coupled to the arm portion 705 of the frame 702, with an eye box 740 extending toward the lens(es) 707, for output of content at an output coupler 744 at which content output by the display device 704 may be visible to the user. In some examples, the output coupler 744 may be substantially coincident with the lens(es) 707.

The wearable device 100 can also include an audio output device 706 (such as, for example, one or more speakers), an illumination device 708, a sensing system 710, a control system 712, at least one processor 714 (which can be an example of the processor 512), and an outward facing image sensor 716 or camera (which can be an example of the camera 502). In some examples, the illumination device 708 can include a light source, such as a red light-emitting diode (LED), that turns on and/or increases output in response to the request to view recently-captured content, or while the wearable device 100 is capturing images, to notify persons other than the user 102 that they have had (or are having) their picture taken. In some implementations, the display device 704 may include a see-through near-eye display. For example, the display device 704 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 707, next to content (for example, digital images, user interface elements, virtual content, and the like) generated by the display device 704. In some implementations, waveguide optics may be used to depict content on the display device 704.

In some implementations, the wearable device 100 may include a gaze tracking device 720 including, for example, one or more sensors 725, to detect and track eye gaze direction and movement. Data captured by the sensor(s) 725 may be processed to detect and track gaze direction and movement as a user input. In some implementations, the sensing system 710 may include various sensing devices and the control system 712 may include various control system devices including, for example, one or more processors 714 operably coupled to the components of the control system 712. In some implementations, the control system 712 may include a communication module providing for communication and exchange of information between the wearable device 100 and other external devices (such as the mobile device 300).

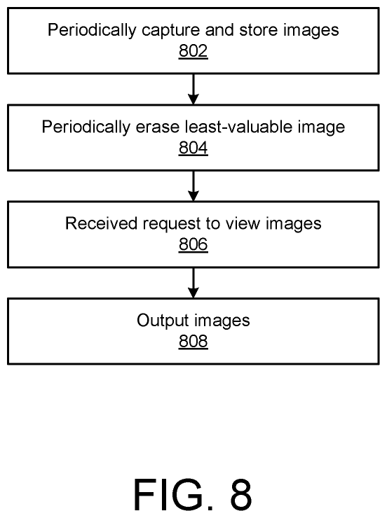

FIG. 8 is a flowchart showing another method performed by the wearable device 100. The method can include, based on a context of a wearable device, periodically capturing and storing, by the wearable device, multiple images, the multiple images being stored in a buffer included in the wearable device (802). The method can include periodically erasing a least-valuable image, from among the multiple images, from the buffer (804). The method can include receiving a request to view the multiple images stored in the buffer (806). The method can include, in response to the request to view the multiple images stored in the buffer, outputting the multiple images stored in the buffer (808).

In some examples, the method can further include determining a selected image based on receiving a selection of one of multiple images, erasing images from the multiple images other than the selected image, and transferring the selected image from the buffer to long-term storage.

In some examples, the least-valuable image can include an oldest-captured image.

In some examples, the outputting of the multiple images can include sending the multiple images to a mobile device, and prompting the mobile device to display the multiple images.

In some examples, the outputting of the multiple images can include displaying the multiple images.

In some examples, the wearable device can include a head-mounted device.

In some examples, the multiple images can have lower resolutions than a maximum resolution of a camera included in the wearable device.

In some examples, the periodically capturing the images can be performed without user instruction.

In some examples, the periodically erasing the least-valuable image can be performed without user instruction.

In some examples, a period between capturing images within the multiple images can be at least half of a second.

In some examples, an oldest image from the multiple images stored in the buffer was captured at least three seconds before a current time.

In some examples, an oldest image from the multiple images stored in the buffer was captured no more than fifteen seconds before a current time.

In some examples, the method can further include, in response to the request to view the multiple images stored in the buffer, increasing an output of a light source included in the wearable device.

In some examples, the method can further include determining that an interest level satisfies an interest threshold, the interest level being based on images captured before the multiple images, wherein the storing the multiple images is performed based on the interest level satisfying the interest threshold.

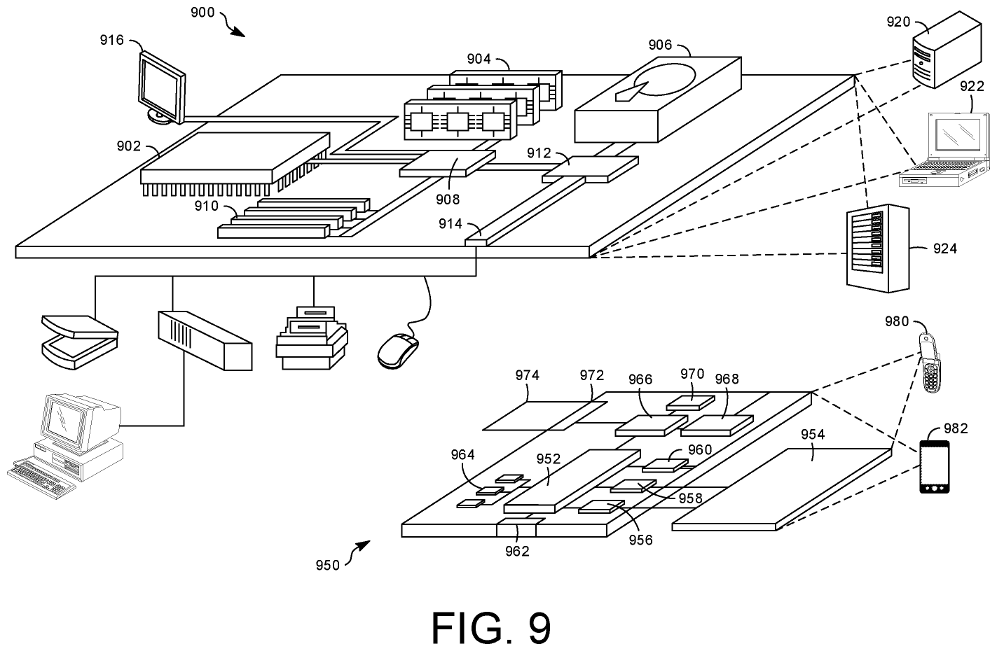

FIG. 9 shows an example of a generic computer device 900 and a generic mobile computer device 950, which may be used with the techniques described here. Computing device 900 is intended to represent various forms of digital computers, such as laptops, desktops, tablets, workstations, personal digital assistants, televisions, servers, blade servers, mainframes, and other appropriate computing devices. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. The processor 902 can be a semiconductor-based processor. The memory 904 can be a semiconductor-based memory. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provided as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method comprising:
based on a context of a wearable device, periodically capturing and storing, by the wearable device, multiple images, the multiple images being stored in a buffer included in the wearable device;
periodically erasing a least-valuable image, from among the multiple images, from the buffer;
receiving a request to view the multiple images stored in the buffer; and
in response to the request to view the multiple images stored in the buffer, outputting the multiple images stored in the buffer.

2. The method of claim 1, further comprising:
determining a selected image based on receiving a selection of one of multiple images;
erasing images from the multiple images other than the selected image; and
transferring the selected image from the buffer to long-term storage.

3. The method of claim 1, wherein the least-valuable image comprises an oldest-captured image.

4. The method of claim 1, wherein the outputting of the multiple images includes:
sending the multiple images to a mobile device; and
prompting the mobile device to display the multiple images.

5. The method of claim 1, wherein the outputting of the multiple images includes displaying the multiple images.

6. The method of claim 1, wherein the wearable device comprises a head-mounted device.

7. The method of claim 1, wherein the multiple images have lower resolutions than a maximum resolution of a camera included in the wearable device.

8. The method of claim 1, wherein the periodically capturing the images is performed without user instruction.

9. The method of claim 1, wherein the periodically erasing the least-valuable image is performed without user instruction.

10. The method of claim 1, wherein a period between capturing images within the multiple images is at least half of a second.

11. The method of claim 1, wherein an oldest image from the multiple images stored in the buffer was captured at least three seconds before a current time.

12. The method of claim 1, wherein an oldest image from the multiple images stored in the buffer was captured no more than fifteen seconds before a current time.

13. The method of claim 1, further comprising, in response to the request to view the multiple images stored in the buffer, increasing an output of a light source included in the wearable device.

14. The method of claim 1, further comprising:
determining that an interest level satisfies an interest threshold, the interest level being based on images captured before the multiple images,
wherein the storing the multiple images is performed based on the interest level satisfying the interest threshold.

15. A wearable device comprising:
a camera;
at least one processor; and
a non-transitory computer-readable storage medium comprising instructions thereon that, when executed by the at least one processor, are configured to cause the wearable device to:
based on a context of a wearable device, periodically capture and store, by the wearable device, multiple images, the multiple images being stored in a buffer included in the wearable device;
periodically erase a least-valuable image, from among the multiple images, from the buffer;
receive a request to view the multiple images stored in the buffer; and
in response to the request to view the multiple images stored in the buffer, output the multiple images stored in the buffer.

16. The wearable device of claim 15, wherein the outputting of the images includes:
sending the images to a mobile device; and
prompting the mobile device to display the images.

17. The wearable device of claim 15, wherein the outputting of the images includes displaying the images.

18. A non-transitory computer-readable storage medium comprising instructions thereon that, when executed by at least one processor, are configured to cause a wearable device to:
based on a context of a wearable device, periodically capture and store, by the wearable device, multiple images, the multiple images being stored in a buffer included in the wearable device;
periodically erase a least-valuable image, from among the multiple images, from the buffer;
receive a request to view the multiple images stored in the buffer; and
in response to the request to view the multiple images stored in the buffer, output the multiple images stored in the buffer.

19. The non-transitory computer-readable storage medium of claim 18, wherein the outputting of the images includes:
sending the images to a mobile device; and
prompting the mobile device to display the images.

20. The non-transitory computer-readable storage medium of claim 18, wherein the outputting of the images includes displaying the images.
